(19) United States
(12) Patent Application Publication
(10) Pub. No.: US 2016/0190532 A1
(43) Pub. Date: Jun. 30, 2016

(54) BATTERY SEPARATOR AND METHOD FOR MAKING THE SAME

(71) Applicants: JIANGSU HUADONG INSTITUTE OF LI-ION BATTERY CO.LTD, Zhangjiagang (CN); TSINGHUA UNIVERSITY, Beijing (CN)

(72) Inventors: PENG ZHAO, Beijing (CN); XIANG-MING HE, Beijing (CN); JU-PING YANG, Beijing (CN); YU-MING SHANG, Beijing (CN); LI WANG, Beijing (CN); JIAN-JUN LI, Beijing (CN); JIAN GAO, Beijing (CN)

(21) Appl. No.: 14/907,298

(22) PCT Filed: Jul. 4, 2014
(86) PCT No.: PCT/CN2014/081691

§ 371 Date: Jan. 25, 2016

(30) Foreign Application Priority Data
Jul. 23, 2013 (CN) 201310309939.1

(51) Int. Cl. H01M 2/14; H01M 10/0525; H01M 2/16

(52) U.S. Cl. CPC H01M 2/145; H01M 2/166; H01M 10/0525; H01M 2220/30; H01M 2220/20

(57) ABSTRACT

A method for making a separator in a lithium ion battery which is less susceptible to high temperature shrinkage provides a polyolefin porous membrane. An oxidant is applied to surface of the polyolefin porous membrane. The polyolefin porous membrane and oxidant are heated in a liquid medium. The liquid medium includes a silicon-oxygen organic compound including a methacryloxy group and at least two alkoxy groups respectively joined to a silicon atom. The silicon-oxygen organic compound is polymerized and chemically grafted to the polyolefin porous membrane to form a grafted polyolefin porous membrane. A condensation reaction then occurs between silicon-oxygen groups in the grafted polyolefin porous membrane in an acidic environment or alkaline environment.

### CROSS-REFERENCE TO RELATED APPLICATIONS

This application claims all benefits accruing under 35 U.S.C. §119 from China Patent Application No. 201310309939.1, filed on Jul. 23, 2013 in the China Intellectual Property Office, the content of which is hereby incorporated by reference. This application is a 35 U.S.C. §371 national application of international patent application PCT/CN2014/081691 filed Jul. 4, 2014.

### FIELD

The present disclosure relates to methods for making separators in lithium ion batteries.

### BACKGROUND

Safety in lithium ion battery in new energy fields such as mobile phones, vehicles, and energy storage systems is an issue. Based on causal analysis, the safety of lithium ion battery could be improved in the following ways: one is to optimize the design and power management of lithium ion battery, monitor and process the online charge and discharge of the lithium ion battery, and keep the lithium ion battery safe in use. Another way is to develop a new electrode material having an intrinsically safe performance. A third way is to adopt safe electrolyte and separator.

The separator transports ions and maintains electrical isolation between cathode and anode, to avoid short circuits in an inner structure of the lithium ion battery. Conventional separators used in lithium ion batteries are microporous membranes made of polyolefin, such as polypropylene (PP) or polyethylene(PE), produced by using physical methods (such as stretching) or chemical methods (such as extracting). Commercial separator brands are Asahi, Tonen, and Ube from Japan, and Celgard from US. As a matrix of the separator, polyolefin is a polymer offering excellent mechanical strength, good acid and alkaline endurance, and good solvent stability. However, polyolefin has a low melting point (130° C.˜160° C.) and can easily be shrunk or melted down at a relatively low temperature. When thermal runaway occurs in the lithium ion battery, to increase the temperature to the melting point, the separator exhibits shrinkage on meltdown, which causes a short circuit between the cathode and anode. The internal shorting exacerbates the thermal runaway, leading to the battery burning or exploding.

The thermal safety can be improved by coating ceramic nano particles (such as SiO₂ nano powder) on the surface of the polyolefin separator. However, the nano particles that are aggregated in the coating produce non-uniform currents, and the detachment of particles also occurs.

### SUMMARY

What is need, therefore, is to provide a separator having good thermal resistance and method for making the same.

A method for making a separator of a lithium ion battery comprising: providing a polyolefin porous membrane; applying an oxidant to a surface of the polyolefin porous membrane; heating the polyolefin porous membrane having the oxidant adsorbed thereon in a liquid medium, the liquid medium comprising a silicon-oxygen organic compound comprising a methacryloxy group and at least two alkoxy groups, the at least two alkoxy groups and the methacryloxy group are respectively joined to a silicon atom, and the silicon-oxygen organic compound being polymerized and chemically grafted to the polyolefin porous membrane to form a grafted polyolefin porous membrane; and having a condensation reaction between silicon-oxygen groups in the grafted polyolefin porous membrane in an acidic environment or alkaline environment thereby forming a silicon-oxygen hybrid crosslinked network grafted to the polyolefin porous membrane.

A method for making a separator of a lithium ion battery comprising: providing a polyolefin porous membrane; applying an oxidant to a surface of the polyolefin porous membrane; heating the polyolefin porous membrane having the oxidant adsorbed thereon in a first liquid medium, the first liquid medium comprising a first silicon-oxygen organic compound comprising a methacryloxy group and at least one alkoxy group, the at least one alkoxy group and the methacryloxy group being respectively joined to a first silicon atom, and the first silicon-oxygen organic compound being polymerized and chemically grafted to the polyolefin porous membrane to form a grafted polyolefin porous membrane; disposing the grafted polyolefin porous membrane in a second liquid medium to have a second silicon-oxygen organic compound in the second liquid medium adsorbed on the grafted polyolefin porous membrane, the second silicon-oxygen organic compound comprising at least two alkoxy groups, the at least two alkoxy groups are respectively joined to a second silicon atom; and having a condensation reaction between silicon-oxygen groups of the first silicon-oxygen organic compound and the second silicon-oxygen organic compound in an acidic environment or alkaline environment thereby forming a silicon-oxygen hybrid crosslinked network grafted to the polyolefin porous membrane.

A separator of a lithium ion battery, the separator comprising a polyolefin porous membrane and a silicon-oxygen hybrid crosslinked network grafted on the polyolefin porous membrane, wherein the silicon-oxygen hybrid crosslinked network comprises a chemical group

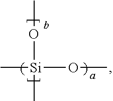

wherein a and b are both in a range of 1˜10000 and independent of each other.

The silicon-oxygen hybrid crosslinked network and the polyolefin porous membrane are connected by grafting to form an organic-inorganic hybrid system. The chemical bonds are strong, preventing the detaching of the silicon-oxygen hybrid crosslinked network from the polyolefin porous membrane. The silicon-oxygen hybrid crosslinked network is a uniform organic substance located in the micropores of the polyolefin porous membrane which provides good structural support at high temperatures.

### BRIEF DESCRIPTION OF THE DRAWINGS

FIG. 1 shows a Fourier transform infrared spectroscopy (FT-IR) of (a) untreated Celgard-2300 separator in Comparative Example; (b) TEPM; (c) Celgard-PTEPM-2h separator; (d) Celgard-SiO2-2h separator; (e) Celgard-SiO₂-2h-TEOS-30% separator; (f) Celgard-SiO₂-2h-TEOS-30% separator after ultrasonically vibration and adhesive tape treatment.

FIG. 2 shows photographs of Celgard-SiO₂-2h-TEOS-30% separator before (left) and after (right) being exposed to 150° C. for 0.5 h.

FIG. 3 shows photographs of untreated Celgard-2300 separator in Comparative Example before (left) and after (right) being exposed to 150° C. for 0.5 h.

FIG. 4 shows thermal shrinkage (%) of separators in Examples 3, 7, and Comparative Example at various temperatures.

FIG. 5 shows cycling performances of lithium ion batteries in Examples 1˜9 and Comparative Example.

FIG. 6 shows cycling performances at various current rates of lithium ion batteries in Examples 1˜9 and Comparative Example.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

One embodiment of a separator comprises a polyolefin porous membrane and a silicon-oxygen hybrid crosslinked network grafted on the polyolefin porous membrane. The silicon-oxygen hybrid crosslinked network comprises a chemical group

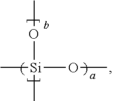

wherein a and b are both in a range of 1˜10000 and independent of each other.

The silicon-oxygen hybrid crosslinked network can be grafted on the polyolefin porous membrane through a polymethacrylate group.

The silicon-oxygen hybrid crosslinked network can be directly joined to the polymethacrylate group by a chemical bond or connected to thepolymethacrylate group by a functional group.

A method for making a separator of a lithium ion battery including steps S11 to S14 is provided by way of example.

At step S11, a polyolefin porous membrane is provided.

At step S12, an oxidant is applied to a surface of the polyolefin porous membrane.

At step S13, a liquid medium comprising a silicon-oxygen organic compound is provided. The silicon-oxygen organic compound comprises a methacryloxy group and at least two alkoxy groups. The alkoxy group and the methacryloxy group are respectively joined to a silicon atom. The polyolefin porous membrane having the oxidant adsorbed thereon is heated in the liquid medium, thereby the silicon-oxygen organic compound is polymerized and chemically grafted to the polyolefin porous membrane.

At step S14, an acidic environment or alkaline environment is provided and the grafted polyolefin porous membrane is located therein to have a condensation reaction in silicon-oxygen groups thereby forming the silicon-oxygen hybrid crosslinked network. The silicon-oxygen hybrid crosslinked network is grafted to the polyolefin porous membrane.

At step S11, the polyolefin porous membrane can be selected from a polypropylene porous membrane, a polyethylene porous membrane, or a lamination of a polypropylene porous membrane and a polyethylene porous membrane. The polyolefin porous membrane can be a conventional separator in a lithium ion battery, transporting ions through the pores but maintaining electrical isolation between cathode and anode. The polyolefin porous membrane can be obtained from Asahi, Tonen, or Ube in Japan, or Celgard in US. In one embodiment, a Celgard-2300 type separator is used as the polyolefin porous membrane.

At step S12, in one embodiment, a liquid solution containing the oxidant can be coated on the surfaces of the polyolefin porous membrane. In another embodiment, the polyolefin porous membrane can be immersed in the oxidant liquid solution. Free radicals are produced on the polyolefin porous membrane under the action of the oxidant when heated.

The oxidant is capable of being dissolved in a solvent to form the liquid solution. The oxidant can be selected from benzoyl peroxide (BPO), cumene hydroperoxide, di-tert-butyl peroxide, tert-butyl peroxybenzoate, or combinations thereof. The solvent can be selected from ether, acetone, chloroform, ethyl acetate, or combinations thereof. The concentration of the oxidant in the liquid solution is not limited as long as the following chemical grafting process is followed. To avoid over breaking the molecular chains of the polyolefin, the oxidant in the liquid solution can have a relatively low concentration, such as 1%-12% by mass. In one embodiment, the oxidant is BPO, the solvent is acetone, and the mass concentration is about 2.5%. The oxidant can be applied to the polyolefin porous membrane at room temperature.

After step S12, the polyolefin porous membrane can be dried at room temperature to remove the residual solvent. After the solvent is dried, the oxidant is left on the surfaces or in the pores of the polyolefin porous membrane.

At step S13, the silicon-oxygen organic compound comprises the methacryloxy group (H₂C═C(CH₃)COO—) and the alkoxy groups (—OR₁) respectively joined directly to the Si atom. Thereby, the silicon-oxygen organic compound comprises silicon-oxygen groups. The at least two alkoxy groups can be same or different. The silicon-oxygen organic compound comprises a group represented by —Si(OR₁)ₓ(R₂)_{y}, wherein x+y=3, x≧2, y≧0. In one embodiment, x=3, y=0. R₂ is hydrocarbon group or H atom, such as alkyl group (e.g., —CH₃ or —C₂H₅). R₁ is alkyl group, such as —CH₃ or —C₂H₅. The methacryloxy group and the —Si(OR₁)ₓ(R₂)_{y} can be joined together directly or connected by an organic functional group, such as alkyl groups, alkenyl groups, alkynyl groups, cycloalkyl groups, and aromatic groups.

One embodiment of a chemical formula of the silicon-oxygen organic compound can be:

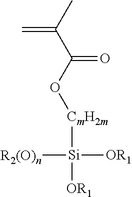

wherein n=0 or 1, m=1˜5. In one embodiment, n=1 and m=3.

The silicon-oxygen organic compound can be selected from 3-(triethoxysilyl)propyl methacrylate (TEPM), 3-(trimethoxysilyl)propyl methacrylate (TMPM), 3-methacryloxypropylmethyldimethoxysilane, methacryloxypropylmethyldiethoxysilane, or combinations thereof.

The silicon-oxygen organic compound can be either soluble or insoluble in the liquid medium. In one embodiment, the silicon-oxygen organic compound is insoluble in the liquid medium, which can be at least one of water and alkanes such as hexane and petroleum ether. The silicon-oxygen organic compound is adsorbed on the surfaces or in the pores of the polyolefin porous membrane. The chemical grafting connects the silicon-oxygen organic compound with the polyolefin porous membrane by chemical bonds to form the grafted polyolefin porous membrane.

The polyolefin porous membrane having the oxidant adsorbed can be immersed in the liquid medium having the silicon-oxygen organic compound and heated at a temperature of 85° C.˜95° C. for 1 hour˜5 hours. The mass concentration of the silicon-oxygen organic compound in the liquid medium is not limited, it can be 0.2%˜99%, and further can be 10%˜50% in one embodiment.

When heated, the oxidant breaks some C—H bonds in the polyolefin of the polyolefin porous membrane to form free radicals. Under the action of the free radicals, some unsaturated C═C bonds of the methacryloxy group open in the silicon-oxygen organic compound and bond to carbon atoms with the free radicals to form the grafting in the polyolefin on one hand. The unsaturated C═C bonds also polymerize with each other to form a relatively long C—C chain, thereby forming the polymethacrylate group (CH₂═C(CH₃)COO)ₖ on the other hand. For example, the polymethacrylate group can be:

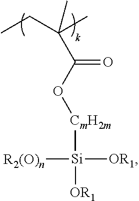

wherein k is 2˜10000.

At step S13, when carbon number of —OR₁ is 2 or above, a hydrolysis reaction occurs at a low speed that can be ignored at a neutral condition. When the carbon number of —OR₁ is 1, a non-water solvent can be used to avoid the hydrolysis reaction. Therefore, the grafting and polymerizing of the methacryloxy group only occur at step S13, and the chemical group —Si(OR₁)ₓ(R₂)_{y} can be maintained.

The breaking of the molecular chains of the polyolefin in the polyolefin porous membrane by the action of the oxidant is prevented by controlling a reacting or heating time in the liquid medium and by an amount and type of oxidant. The grafted polyolefin porous membrane after step S13 is still capable of functioning as a separator of the battery.

In some embodiments, at step S13, some molecules of the silicon-oxygen organic compound may undergo polymerization but are not grafted to the polyolefin porous membrane. To prevent the formed polymer blocking the micropores of the polyolefin porous membrane, and so decreasing the battery performance, a step such as ultrasound rinsing or Soxhlet extraction can be further applied to the grafted polyolefin porous membrane after step S13. For example, the grafted polyolefin porous membrane can be ultrasonically vibrated in a solvent and then dried in a vacuum. The ungrafted polymer and residual reactants can thus be rinsed away from the grafted polyolefin porous membrane. The solvent, such as acetone or tetrahydrofuran, dissolves any polymer formed from the silicon-oxygen organic compound.

At step S14, the acidic environment can be an acidic atmosphere or an acidic liquid, with pH of <3 in one embodiment. The alkaline environment can be an alkaline atmosphere or an alkaline liquid, with pH of >10 in one embodiment. The acidic environment can be formed by acids such as hydrochloric acid, acetic acid, nitric acid, or sulfuric acid. The alkaline environment can be formed by alkalis such as ammonia gas, ammonia water, or sodium carbonate solution. A condensation reaction occurs between the alkoxy groups that are directly joined to the silicon atoms of the polyolefin porous membrane in the acidic environment or the alkaline environment, represented by the equation:

—SiOR₁+—SiOR₁→—Si—O—Si—,

The silicon atoms and the oxygen atoms are directly joined to form a silicon-oxygen chain in the condensation reaction. The silicon-oxygen organic compound comprises at least two Si—O bonds, enabling the product of the condensation reaction to comprise a silicon-oxygen hybrid crosslinked network. In the silicon-oxygen hybrid crosslinked network, at least two silicon-oxygen chains cross with each other and at least one silicon atom is shared at the crossing point to form the chemical group

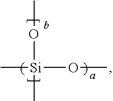

wherein a and b are both in a range of 1˜10000 and independent of each other. Two or more chemical groups

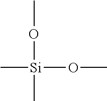

can be joined with each other to form a unit

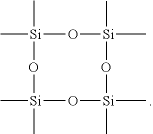

In one embodiment, the chemical group

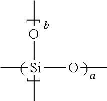

can be joined to the silicon-oxygen chains to form more complicated structures such as silicon-oxygen rings in the following form:

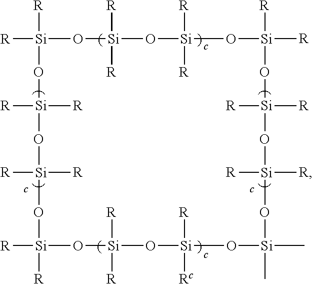

The parameter c in different silicon-oxygen chains can be each independently selected from 1˜10000. The R at different positions, representing a chemical group such as hydrocarbon groups, epoxy groups, amino groups, or hydrogen atom, can be the same or different. In one embodiment, R at different positions are each independently selected from alkyl groups.

In one embodiment, the silicon-oxygen hybrid crosslinked network comprises a plurality of silicon-oxygen chains crossed with each other, wherein each silicon atom is joined directly to four oxygen atoms, to form a network structure.

The silicon-oxygen hybrid crosslinked network can be directly joined or connected through the various chemical groups to the polymethacrylate group, thereby achieving the grafting to the polyolefin separator. The silicon-oxygen hybrid crosslinked network also can be joined with hydrogen atom, oxygen atom, or chemical groups such as alkyl groups or hydroxyl groups.

The silicon-oxygen hybrid crosslinked network having the silicon-oxygen chains crossed with each other at various directions is a strong structural supporter that is grafted on the polyolefin porous membrane, to prevent thermal shrinkage of the polyolefin porous membrane.

A method for making a separator in a lithium ion battery including steps S21 to S25 is provided by way of example.

At step S21, a polyolefin porous membrane is provided.

At step S22, an oxidant is applied to a surface of the polyolefin porous membrane.

At step S23, a first liquid medium comprising a first silicon-oxygen organic compound is provided. The first silicon-oxygen organic compound comprises a methacryloxy group and at least one alkoxy group. The alkoxy group and the methacryloxy group are respectively joined directly to a silicon atom. The polyolefin porous membrane having the oxidant adsorbed thereon is heated in the first liquid medium, thereby the first silicon-oxygen organic compound is polymerized and chemically grafted to the polyolefin porous membrane.

At step S24, a second liquid medium comprising a second silicon-oxygen organic compound is provided. The second silicon-oxygen organic compound comprises at least two alkoxy groups. The alkoxy groups are respectively joined directly to a silicon atom. The grafted polyolefin porous membrane formed at step S23 is disposed in the second liquid medium, to have the second silicon-oxygen organic compound adsorbed on the grafted polyolefin porous membrane.

At step S25, an acidic environment or alkaline environment is provided. The grafted polyolefin porous membrane having the second silicon-oxygen organic compound adsorbed thereon is put in the acidic environment or alkaline environment to undergo a condensation reaction in silicon-oxygen groups of the first silicon-oxygen organic compound and the second silicon-oxygen organic compound. The condensation reaction forms the silicon-oxygen hybrid crosslinked network. The silicon-oxygen hybrid crosslinked network is grafted to the polyolefin porous membrane.

Steps S21˜S22 are the same as steps S11˜S12.

Step S23 is the same as step S13 except that:

At step S23, the first silicon-oxygen organic compound comprises a methacryloxy group (H₂C═C(CH₃)COO—) and —Si(OR₁)ₓ(R₂)_{y}, wherein x+y=3, x≧1, y≧0. In one embodiment, x=3 and y=0. The —R₂ joined directly to the silicon atom can be the same or different, and can be each independently selected from hydrocarbon groups and hydrogen atom. In one embodiment, the —R₂ can be each independently selected from alkyl groups such as —CH₃ and —C₂H₅. The —OR₁ joined directly to the silicon atom can be the same or different, and can be each independently selected from alkyl groups such as —CH₃ and —C₂H₅. The methacryloxy group and the —Si(OR₁)ₓ(R₂)_{y} can be directly joined with each other or connected together through a chemical functional group such as alkyl groups, alkenyl groups, alkynyl groups, cycloalkyl groups, or aromatic groups. One embodiment of the first silicon-oxygen organic compound can be represented by a formula of:

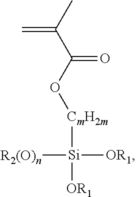

wherein each n can be independently 0 or 1, and m can be 1˜5. In one embodiment, n=1 and m=3. The first silicon-oxygen organic compound can comprise only one alkoxy group that is joined directly to the Si atom.

The first silicon-oxygen organic compound can be selected from 3-(triethoxysilyl)propyl methacrylate (TEPM), 3-(trimethoxysilyl)propyl methacrylate (TMPM), 3-methacryloxypropylmethyldimethoxysilane, methacryloxypropylmethyldiethoxysilane, 3-methacryloxypropyldimethylethoxysilane, 3-methacryloxypropyldimethylmethoxysilane, or combinations thereof.

The mass concentration of the first silicon-oxygen organic compound in the first liquid medium can be relatively small such as 0.2%˜7.5%, or 0.5%˜5%.

At step S23, the chemical group

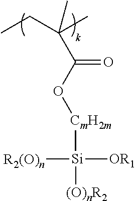

can be formed and grafted to the polyolefin porous membrane to form the grafted polyolefin porous membrane, wherein k is 2˜10000.

After step S23, a step such as ultrasound rinsing or Soxhlet extraction can be further applied to the grafted polyolefin porous membrane. The ungrafted polymer and residual reactants can thus be rinsed away from the grafted polyolefin porous membrane.

At step S24, the grafted polyolefin porous membrane can be immersed in the second liquid medium having the second silicon-oxygen organic compound for a period of time between 30 minutes and 4 hours. The period of time can be adjusted according to the desired amount of the second silicon-oxygen organic compound adsorbed on the surface of the grafted polyolefin porous membrane. At step S24, the second silicon-oxygen organic compound is combined with the grafted polyolefin porous membrane by an intermolecular force only, and not by any chemical bond.

The second silicon-oxygen organic compound can be represented by formula:

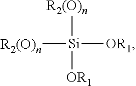

wherein each n can be independently 0 or 1. In one embodiment, n=1. The plurality of —OR₁ joined directly to the silicon atom can be the same or different, and each can be independently selected from alkyl groups, such as —CH₃ and 13 C₂H₅. The plurality of —R₂ joined directly to the silicon atom can be the same or different, and each can be independently selected from organic groups such as hydrocarbon groups, epoxy groups, amino groups, or hydrogen atom. In one embodiment, each of the plurality of —R₂ is independently selected from alkyl groups, such as —CH₃ or —C₂H₅.

The alkoxy groups in the second silicon-oxygen organic compound can be as many as possible. In one embodiment, the second silicon-oxygen organic compound comprises four alkoxy groups that are joined directly to the silicon atom. For example, the second silicon-oxygen organic compound can be at least one of tetraethyl orthosilicate (TEOS), tetramethoxysilane, 3-glycidoxypropyltrimethoxysilane, and 3-aminopropyltriethoxysilane.

The second silicon-oxygen organic compound can be dissolved in the second liquid medium, to form the second silicon-oxygen organic compound solution. The mass concentration of the second silicon-oxygen organic compound in the solution can be larger than zero but smaller than or equal to 50%. In one embodiment, the mass concentration of the second silicon-oxygen organic compound can be 10%˜50%. The second silicon-oxygen organic compound has a relatively high concentration to provide a large amount of Si—O groups. The first and second liquid mediums can be an organic solvent, such as toluene, acetone, ether, isopropyl alcohol, or combinations thereof.

Step S25 is the same as step S15, except that both the first and second silicon-oxygen organic compounds undergo the condensation reaction. There is a condensation reaction between the alkoxy groups of the first silicon-oxygen organic compound and the silicon-oxygen groups of the second silicon-oxygen organic compound. The formed silicon-oxygen hybrid crosslinked network has a relatively larger molecular weight and more

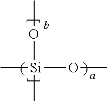

units than those characteristics in the method 100.

By using the second silicon-oxygen organic compound, a relatively low mass concentration of the first silicon-oxygen organic compound decreases the amount of grafting and increases the amount of the silicon-oxygen hybrid crosslinked network. The oxidant has an amount that corresponds to the amount of the first silicon-oxygen organic compound, and also has a low mass concentration, which reduces the destruction of the structure of polyolefin porous membrane at the grafting step. The increased amount of the silicon-oxygen hybrid crosslinked network improves the thermal resistance of the separator.

### EXAMPLE 1

A Celgard-2300 separator is immersed in a BPO acetone solution (BPO has a concentration of 2.5%, w/w) for about 1 hour, taken out, and dried at room temperature. Then the separator is immersed in a TEPM water solution (TEPM has a concentration of 1%, v/v), and heated at about 90° C. for about 2 hours. After that, the separator is taken from the TEPM water solution and ultrasonically vibrated in acetone to remove the ungrafted TEPM. Finally, the separator is dried in a vacuum for about 12 hours to obtain the separator, labeled as Celgard-PTEPM-2h.

### EXAMPLE 2

Example 2 is the same as Example 1, except that the separator is heated at 90° C. for about 4 hours in the TEPM water solution. The obtained separator is labeled as Celgard-PTEPM-4h.

### EXAMPLE 3

The separator Celgard-PTEPM-2h of Example 1 is exposed in 37.5% (v/v) of HCl gas atmosphere for about 24 hours, and then washed by deionized water and ultrasonically vibrated in acetone. Finally, the separator is dried and labeled as Celgard-SiO₂-2h.

### EXAMPLE 4

The separator Celgard-PTEPM-4h of Example 2 is immersed in 3% (w/w) of HCl liquid solution for about 24 hours, and then washed by deionized water and ultrasonically vibrated in acetone. Finally, the separator is dried and labeled as Celgard-SiO₂-4h.

### EXAMPLE 5

The separator Celgard-PTEPM-2h of Example 1 is immersed in 10% (w/w) of TEOS toluene solution for about 1 hour, and taken out and dried at room temperature. After that, the separator is exposed in 37.5% (v/v) of HCl gas atmosphere for about 24 hours, and then washed by deionized water and ultrasonically vibrated in acetone. Finally, the separator is dried in a vacuum for about 12 hours and labeled as Celgard-SO₂-2h-TEOS-10%.

### EXAMPLE 6

Example 6 is the same as Example 5, except that the concentration of TEOS toluene solution is 20% (w/w). The obtained separator is labeled as

Celgard-SiO₂-2h-TEOS-20%.

### EXAMPLE 7

Example 7 is the same as Example 5, except that the concentration of TEOS toluene solution is 30% (w/w). The obtained separator is labeled as Celgard-SiO₂-2h-TEOS-30%.

### EXAMPLE 8

The separator Celgard-PTEPM-4h of Example 2 is immersed in 10% (w/w) of TEOS toluene solution for about 1 hour, and taken out and dried at room temperature. After that, the separator is exposed in 37.5% (v/v) of HCl gas atmosphere for about 24 hours, and then washed by deionized water and ultrasonically vibrated in acetone. Finally, the separator is dried in vacuum for about 12 hours and labeled as Celgard-SiO₂-4h-TEOS-10%.

### EXAMPLE 9

Example 9 is the same as Example 8, except that the concentration of TEOS toluene solution is 20% (w/w). The obtained separator is labeled as Celgard-SiO₂-4h-TEOS-20%.

### COMPARATIVE EXAMPLE

Untreated pristine Celgard-2300 separator.

Fourier transform infrared spectroscopy (FT-IR) analysis.

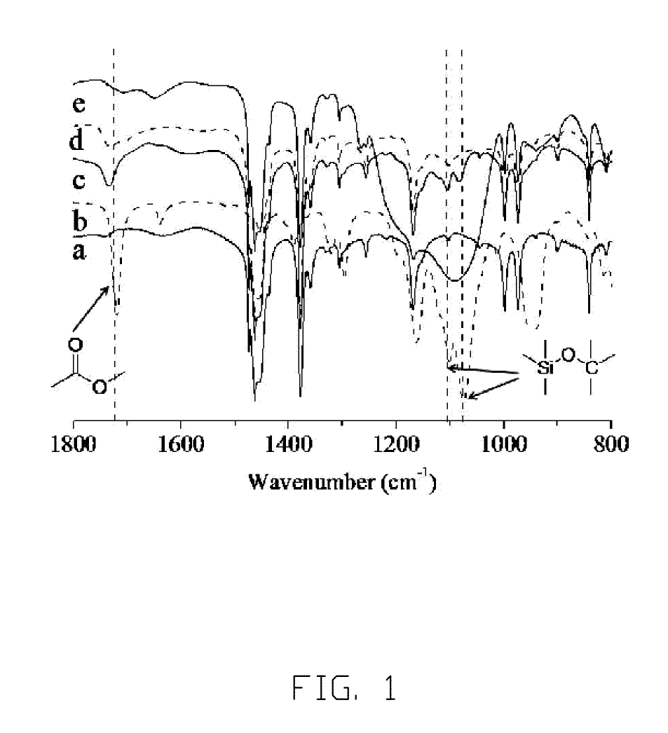

Referring to FIG. 1, the separators of Examples and Comparative Example are evaluated as a preliminary by Fourier Transform Infrared Spectroscopy (FT-IR) analysis to identify functional group on the separator. Curve a is the FT-IR spectra of a Celgard-2300 separator in Comparative Example. Curve b is the FT-IR spectra of pure TEPM. Curve c is the FT-IR spectra of Celgard-PTEPM-2h in Example 1. Curve d is the FT-IR spectra of Celgard-SiO₂-2h in Example 3. Curve e is the FT-IR spectra of Celgard-SiO₂-2h-TEOS-30% in Example 7.

Curve b has a characteristic peak corresponding to a carbon-carbon double bond at 1638 cm⁻¹. Curve c has a strong peak at 1728 cm⁻¹ which can be assigned to the stretching of the carbonyl group. The absorption peaks at 1105 cm⁻¹ and 1075 cm⁻¹ can be assigned to asymmetric stretching of Si—O—C bond, while the characteristic peak corresponding to the C═C double bond at 1638 cm⁻¹ disappears completely. These observations demonstrate that the TEPM polymerization reaction does happen and that the Si—O hybrid crosslinked networks are successfully grafted onto the polyolefin porous membrane. After being exposed to hydrochloric acid atmosphere for about 24h, the characteristic peaks corresponding to Si—O—C bond disappear, whereas a broad peak at 1103 cm⁻¹ is observed in curve d. This could be ascribed to the asymmetric Si—O—Si stretching vibration, indicating a successful condensation reaction. When adding the TEOS solution before being exposed to hydrochloric acid atmosphere, the peak intensity that corresponds to Si—O—Si groups increases greatly compared to other groups in curve e. This demonstrates that the condensation reaction of Si—O—Si bonds is efficient and that a large number of Si—O hybrid crosslinked networks are formed. In addition, Celgard-SiO₂-2h-TEOS-30% separator is washed in ultrasonic bath, and an adhesive tape is stuck to and peeled from the Celgard-SiO₂-2h-TEOS-30% separator, to test the physical stability of the silicon-oxygen hybrid crosslinked network on the surface of the polyolefin porous membrane. The peak intensity of Si—O—Si groups in FT-IR spectra in unchanged after the washing treatment, and any change of FT-IR spectra after the treatment of the adhesive tape is found to be insignificant. This demonstrates that strong chemical bonds between silicon-oxygen hybrid crosslinked network and polyolefin porous membrane are formed.

Thermal Shrinkage Test.

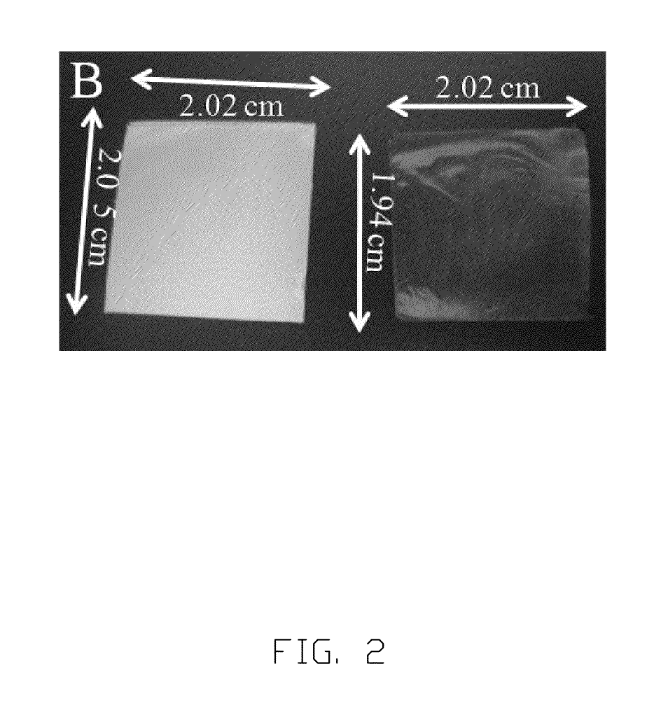

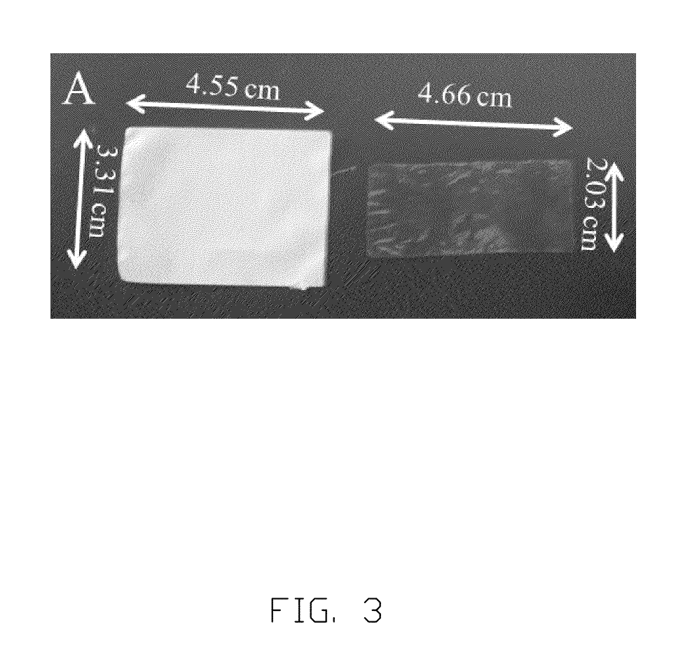

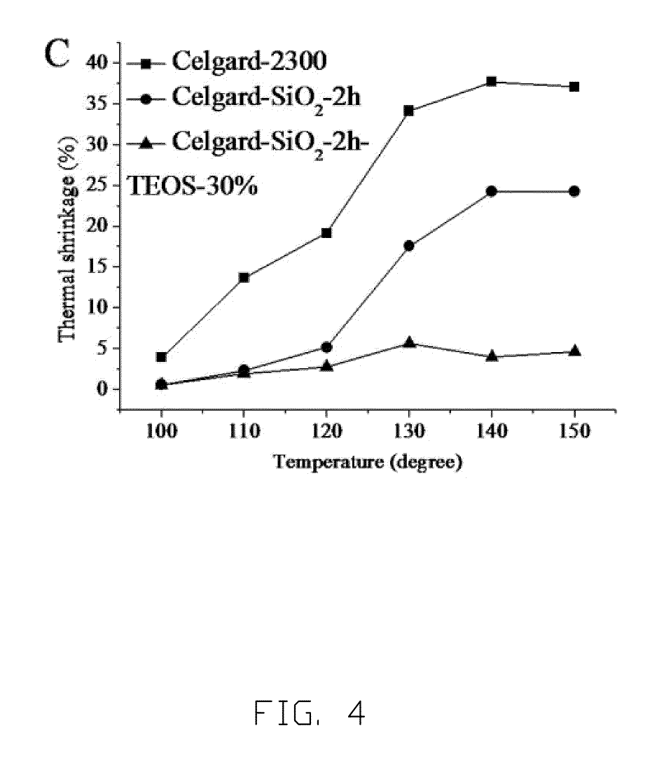

Referring to FIG. 2 and FIG. 3, the separators in Examples 3, 7, and Comparative Example are heated at about 150° C. for about 30 minutes. Thermal shrinkage ratio=(Sb−Sa)/Sb×100%, wherein Sb is the area of the separator before heating and Sa is the area of the separator after heating. As shown in FIG. 2 and FIG. 3, the untreated Celgard-2300 separator has an apparent shrinkage after heating. The area change of Celgard-SiO₂-2h-TEOS-30% separator is negligible in the test. The thermal shrinkages of the separators are shown in FIG. 4 at various temperatures. The Celgard-2300 separator shows a significant thermal shrinkage ratio due to the intrinsically low melting point of polyolefin. The Celgard-SiO2-2h separator and Celgard-SiO2-2h-TEOS-30% separator exhibit less shrinkage, attributed to the silicon-oxygen hybrid crosslinked network grafted on the separators.

Electrochemical Test

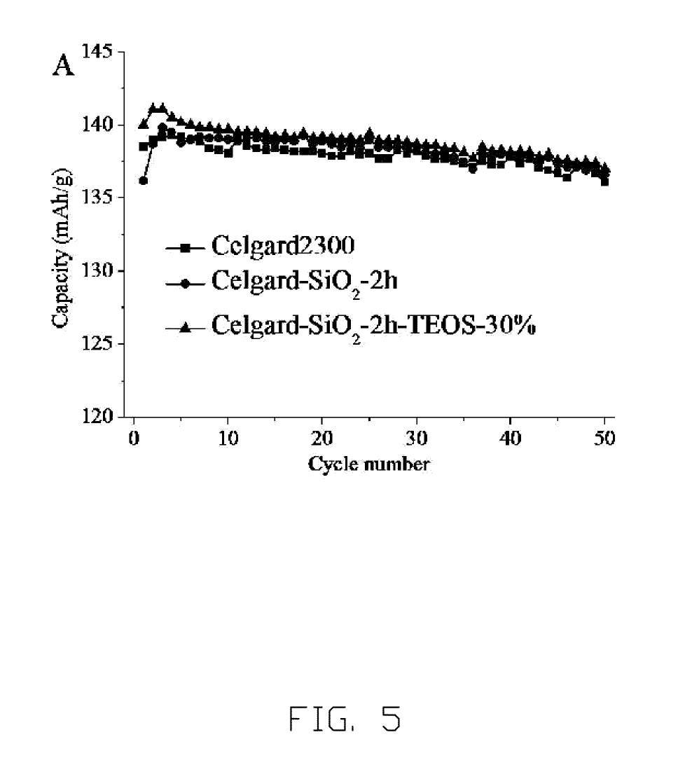

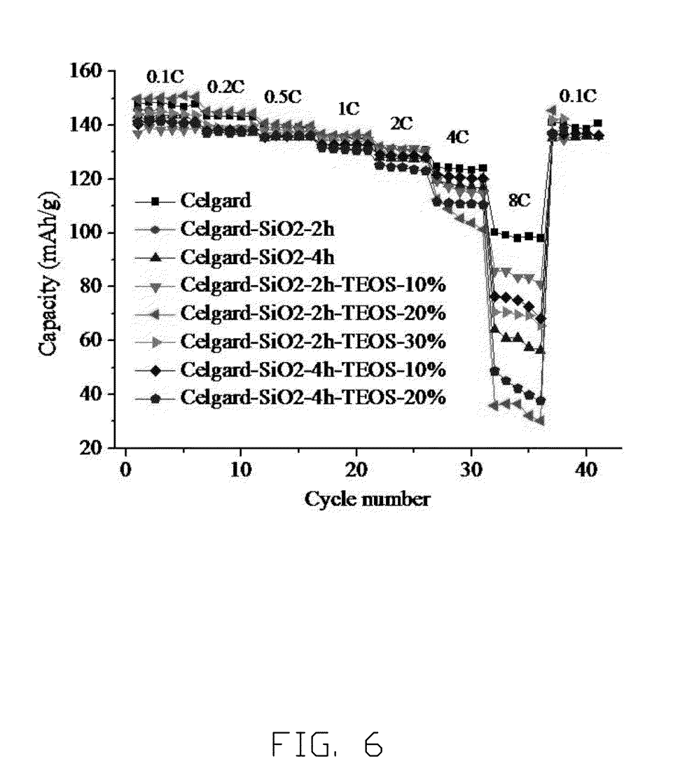

85 wt % of LiCoO₂ is mixed uniformly with 5 wt % of acetylene black, 5 wt % of conductive graphite, and 5 wt % of PVdF, using N-methyl-2-pyrrolidone as the dispersant, and then pressed onto aluminum foil, resulting in a cathode. The anode is lithium metal. The electrolyte solution is 1 mol/L ethylene carbonate and diethyl carbonate (1:1, v/v) dissolved in LiPF₆. Lithium ion batteries using different separators are assembled and cycled at different current densities between 2.75 V and 4.2 V at room temperature. Referring to FIG. 5 and FIG. 6, at relatively low current densities (0.1 C˜2 C), there is no significant difference between the polyolefin porous membranes having the silicon-oxygen hybrid crosslinked networks and the pristine polyolefin porous membrane. At relatively high current densities (4 C˜8 C), the polyolefin porous membranes having the silicon-oxygen hybrid crosslinked networks have a decreased specific capacity. However, by using a relatively low concentration of the TEOS solution, the reduction in specific capacity is less.

The silicon-oxygen hybrid crosslinked network and the polyolefin porous membrane are connected by grafting to form an organic-inorganic hybrid system. The chemical bonds are strong, preventing the detaching of the silicon-oxygen hybrid crosslinked network from the polyolefin porous membrane. The silicon-oxygen hybrid crosslinked network is a uniform organic substance located in the micropores of the polyolefin porous membrane which provides good structural support at high temperatures.

The embodiments shown and described above are only examples. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A method for making a separator of a lithium ion battery comprising:
providing a polyolefin porous membrane;
applying an oxidant to a surface of the polyolefin porous membrane;
heating the polyolefin porous membrane having the oxidant adsorbed thereon in a liquid medium, the liquid medium comprising a silicon-oxygen organic compound comprising a methacryloxy group and at least two alkoxy groups, the at least two alkoxy groups and the methacryloxy group are respectively joined to a silicon atom, and the silicon-oxygen organic compound being polymerized and chemically grafted to the polyolefin porous membrane to form a grafted polyolefin porous membrane; and
having a condensation reaction between silicon-oxygen groups in the grafted polyolefin porous membrane in an acidic environment or alkaline environment thereby forming a silicon-oxygen hybrid crosslinked network grafted to the polyolefin porous membrane.

2. The method of claim 1, wherein the silicon-oxygen organic compound is selected from the group consisting of 3-(triethoxysilyl)propyl methacrylate (TEPM), 3-(trimethoxysilyl)propyl methacrylate (TMPM), 3-methacryloxypropylmethyldimethoxysilane, methacryloxypropylmethyldiethoxysilane, and combinations thereof.

3. The method of claim 1, wherein the silicon-oxygen organic compound is insoluble in the liquid medium.

4. The method of claim 1, further comprising a step of rinsing the grafted polyolefin porous membrane by solvent to remove a polymer that is not grafted to the polyolefin porous membrane after the step of heating the polyolefin porous membrane.

5. The method of claim 1, wherein the polyolefin porous membrane is heated in the liquid medium at a temperature of 85° C.˜95° C.

6. A method for making a separator of a lithium ion battery comprising:
providing a polyolefin porous membrane;
applying an oxidant to a surface of the polyolefin porous membrane;
heating the polyolefin porous membrane having the oxidant adsorbed thereon in a first liquid medium, the first liquid medium comprising a first silicon-oxygen organic compound comprising a methacryloxy group and at least one alkoxy group, the at least one alkoxy group and the methacryloxy group being respectively joined to a first silicon atom, and the first silicon-oxygen organic compound being polymerized and chemically grafted to the polyolefin porous membrane to form a grafted polyolefin porous membrane;
disposing the grafted polyolefin porous membrane in a second liquid medium to have a second silicon-oxygen organic compound in the second liquid medium adsorbed on the grafted polyolefin porous membrane, the second silicon-oxygen organic compound comprising at least two alkoxy groups, the at least two alkoxy groups are respectively joined to a second silicon atom; and
having a condensation reaction between silicon-oxygen groups of the first silicon-oxygen organic compound and the second silicon-oxygen organic compound in an acidic environment or alkaline environment thereby forming a silicon-oxygen hybrid crosslinked network grafted to the polyolefin porous membrane.

7. The method of claim 6, wherein a mass concentration of the first silicon-oxygen organic compound in the first liquid medium is in a range of 0.2%˜7.5%.

8. The method of claim 6, wherein the second silicon-oxygen organic compound is selected from the group consisting of tetraethyl orthosilicate, tetramethoxysilane, 3-glycidoxypropyltrimethoxysilane, 3-aminopropyltriethoxysilane, and combinations thereof.

9. The method of claim 6, wherein a mass concentration of the second silicon-oxygen organic compound in the second liquid medium is 10%˜50%.

10. A separator of a lithium ion battery, the separator comprising a polyolefin porous membrane and a silicon-oxygen hybrid crosslinked network grafted on the polyolefin porous membrane, wherein the silicon-oxygen hybrid crosslinked network comprises a chemical group 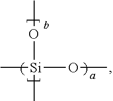
wherein a and b are both in a range of 1˜10000 and independent of each other.

11. The separator of claim 10, wherein the silicon-oxygen hybrid crosslinked network is grafted on the polyolefin porous membrane through a polymethacrylate group.
